(19) United States
(12) Patent Application Publication
(10) Pub. No.: US 2026/0360347 A1
(43) Pub. Date: Nov. 12, 2026

(54) SOUND PROCESSING METHOD, DEVICE, APPARATUS, AND MEDIUM APPLIED IN CABIN OF VEHICLE

(71) Applicant: Beijing Ancsonic Technology Co., Ltd., Beijing (CN)

(72) Inventors: Yifan LIU, Beijing (CN); Yinhai XU, Beijing (CN); Mingzhou ZHAO, Beijing (CN); Yang ZHANG, Beijing (CN); Weihong GAO, Beijing (CN); Wei ZHANG, Beijing (CN); Dan DING, Beijing (CN)

(21) Appl. No.: 19/328,663

(22) Filed: Sep. 15, 2025

(30) Foreign Application Priority Data
May 6, 2025 (CN) 202510571453.8

(51) Int. Cl. G10K 11/178; G10K 11/175; G10L 15/22; H04S 7/00

(52) U.S. Cl. CPC G10K 11/17857; G10K 11/1754; G10K 11/17853; G10L 15/22; H04S 7/302

(57) ABSTRACT

Embodiments of this disclosure disclose a sound processing method, device, apparatus, and medium applied in the cabin of a vehicle. A specific implementation of the method includes: based on the detected conversation statement information in the cabin of a vehicle, determining the first location information corresponding to the conversation statement information; based on the first location information and the conversation statement information, determining whether the conversation statement information meets preset privacy statement conditions; in response to determining that the conversation statement information meets the preset privacy statement conditions, generating the target interference information corresponding to the second location information in the cabin, to process the conversation statement information. This implementation may enhance the effect of conversation in the cabin and improve the user experience in the cabin.

### CROSS-REFERENCE TO RELATED APPLICATIONS

The present application is based on, and claims priority from, Chinese application number 202510571453.8, filed on May 6, 2025, the disclosure of which is hereby incorporated by reference herein in its entirety.

### TECHNICAL FIELD

Embodiments of this disclosure relate to the field of computer technology, and in particular, to a sound processing method, device, apparatus, and medium applied in a cabin of a vehicle.

### BACKGROUND OF THE DISCLOSURE

In the cabin of a vehicle, privacy processing of the sound inside the vehicle may protect the privacy of the conversation content of passengers in the cabin (for example, privacy masking of the conversation content of passengers in the back seat to avoid being heard by the driver). At present, the commonly used method for privacy processing of the sound inside the vehicle is to isolate the private sound inside the vehicle by physical isolation to effect masking.

However, in practice, it has been found that when using the above method to process the sound in the cabin of a vehicle, there are often the following technical issues:

The use of physical isolation for sound insulation in the cabin requires a large amount of sound insulation materials, which seriously damages the optimization design of the cabin space and affects the conversation effect in the cabin when no sound insulation is required, thus resulting in a poor user experience in the cabin.

The above information disclosed in this background section is only for enhancement of understanding of the background of this inventive concept and therefore may contain information that does not form the prior art known to a person having ordinary skill in the art.

### SUMMARY OF THE DISCLOSURE

The content of this disclosure is to briefly introduce concepts, which will be described in detail in the specific implementation section later. This disclosure is not intended to identify key or necessary features of the claimed technical solution, nor is it intended to limit the scope of the claimed technical solution.

Some embodiments of this disclosure propose sound processing method, device, apparatus, and medium applied in the cabin of a vehicle to solve one or more of the technical problems mentioned in the background section above.

In the first aspect, some embodiments of this disclosure provide a sound processing method, device, electronic apparatus, and computer-readable medium applied in the cabin of a vehicle, the method comprising: based on the detected conversation statement information in the cabin of a vehicle, determining the first location information corresponding to the above conversation statement information; based on the above first location information and the above conversation statement information, determining whether the above conversation statement information meets preset privacy statement conditions; in response to determining that the above conversation statement information meets the above preset privacy statement conditions, generating the target interference information corresponding to the second location information in the cabin, to process the above conversation statement information.

In the second aspect, some embodiments of this disclosure provide a sound processing device applied in the cabin of a vehicle, the device comprising: a first determination unit, which is configured to determine, based on the detected conversation statement information in the cabin of a vehicle, the first location information corresponding to the above conversation statement information; a second determination unit, which is configured to determine, based on the above first location information and the above conversation statement information, whether the above conversation statement information meets preset privacy statement conditions; a generation unit, which is configured to generate, in response to determining that the above conversation statement information meets the above preset privacy statement conditions, the target interference information corresponding to the second location information in the cabin, to process the above conversation statement information.

In the third aspect, some embodiments of this disclosure provide an electronic apparatus, which comprises: one or more processors; a storage device storing thereon one or more programs, which, when executed by one or more processors, enable one or more processors to implement the method described in any mode of implementation of the first aspect above.

In the fourth aspect, some embodiments of this disclosure provide a computer-readable medium having a computer program stored thereon, wherein the computer program, when executed by a processor, implements the method described in any mode of implementation of the first aspect above.

The above embodiments of this disclosure have the following beneficial effects: through the sound processing method applied in the cabin of a vehicle by some embodiments of this disclosure, the effect of conversation in the cabin is enhanced and the user experience in the cabin is improved. To be specific, the reason for the rather bad effect of conversation in the cabin and the poor user experience in the cabin is that: using physical isolation methods for sound insulation in the cabin requires a large amount of sound insulation materials, which seriously damages the optimization design of the cabin space and affects the conversation effect in the cabin when no sound insulation is required, thus resulting in a poor user experience in the cabin. On this basis, the sound processing method applied in a vehicle cabin by some embodiments of this disclosure comprises, firstly, based on the detected conversation statement information in a vehicle cabin, determining the first location information corresponding to the above conversation statement information. From this, the location where the sound is emitted may be determined. Then, based on the above first location information and the above conversation statement information, determining whether the above conversation statement information meets preset privacy statement conditions. From this, it may be determined that the content of the conversation is private and whether it needs to be treated as private. Lastly, in response to determining that the above conversation statement information meets the above preset privacy statement conditions, generating the target interference information corresponding to the second location information in the cabin, to process the above conversation statement information. Therefore, when the conversation content is private, interference information may be generated to effect sound masking. It is also because the sound is not isolated by physical isolation methods, but is masked by generating interfering sounds, deterioration of the spatial structure design of the cabin is avoided, and impact on the conversation effect in the cabin when no sound insulation is required is also reduced, thereby improving the user experience. As a result, the conversation effect in the cabin may be enhanced and the user experience in the cabin improved.

### BRIEF DESCRIPTION OF THE DRAWINGS

The above and other features, advantages, and aspects of the embodiments of this disclosure will become more apparent in conjunction with the accompanying drawings and with reference to the following specific implementations. Throughout the drawings, the same or similar reference signs indicate the same or similar elements. It should be understood that the drawings are schematic, and the components and elements are not necessarily drawn to scale.

FIG. 1 is a flowchart of some embodiments of the sound processing method applied in the cabin of a vehicle according to this disclosure;

FIG. 2 is a schematic diagram of the structure of some embodiments of the sound processing device applied in the cabin of a vehicle according to this disclosure;

FIG. 3 is a schematic diagram of the structure of the electronic apparatus suitable for effecting some embodiments of this disclosure.

### DETAILED DESCRIPTION OF THE DISCLOSURE

Hereinafter, the embodiments of this disclosure will be described in more detail with reference to the accompanying drawings. Although certain embodiments of this disclosure are shown in the drawings, it should be understood that this disclosure may be implemented in various forms, and shall not be construed as being limited to the embodiments set forth herein. On the contrary, these embodiments are provided for a more thorough and complete understanding of this disclosure. It should be understood that the drawings and embodiments of this disclosure are used only for illustrative purposes, not to limit the protection scope of this disclosure.

Besides, it should be noted that, for ease of description, only the portions related to the relevant disclosure are shown in the drawings. In the case of no conflict, the embodiments in this disclosure and the features in the embodiments may be combined with each other.

It should be noted that such concepts as “first” and “second” mentioned in this disclosure are only used to distinguish different devices, modules or units, and are not used to limit the order of functions performed by these devices, modules or units or interdependence thereof.

It should be noted that such adjuncts as “one” and “more” mentioned in this disclosure are illustrative, not restrictive, and those skilled in the art should understand that, unless the context clearly indicates otherwise, they should be understood as “one or more”.

The names of messages or information exchanged between multiple devices in the embodiments of this disclosure are only for illustrative purposes, and are not intended to limit the scope of these messages or information.

This disclosure will be described in detail below with reference to the accompanying drawings and in conjunction with embodiments.

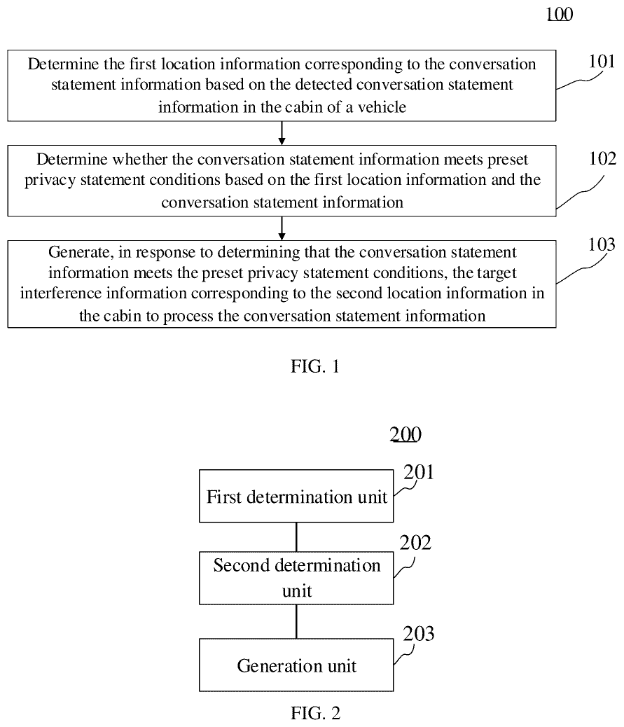

FIG. 1 illustrates a flow 100 of some embodiments of the sound processing method applied in the cabin of a vehicle according to this disclosure. The sound processing method applied in the cabin of a vehicle comprises the following steps:

Step 101: Based on the detected conversation statement information in the cabin of a vehicle, determining the first location information corresponding to the conversation statement information.

In some embodiments, the executing body (such as a computing device) of the sound processing method applied in the cabin of a vehicle can, based on the detected conversation statement information in the cabin of a vehicle, determine first location information corresponding to the above conversation statement information. Wherein, the above conversation statement information may characterize the conversation voice of the user in the cabin. The first location information above may characterize the location of the sound source of the above conversation statement information. For example, the sound source may be the driver, passenger, car stereo, etc. Correspondingly, the first location information mentioned above may be the driver's seat location, the seat location of each passenger, and the installation location of the car stereo.

In certain optional implementation methods of some embodiments, the executing body can, based on the detected conversation statement information in the cabin of a vehicle, determine first location information corresponding to the above conversation statement information through the following steps:

The first step is to perform sound source orientation on the above conversation statement information, to obtain the location information corresponding to the above conversation statement information as the first location information.

In the process of adopting technical solutions to solve the above technical problem 1, the following technical problem 2 often accompanies it: directly performing sound source orientation to the detected speech signal without considering preprocessing the detected speech signal results in low accuracy in sound source orientation performed directly according to the detected speech signal, leading to low accuracy in generating interference information and poor user experience. The conventional solution to the above technical problem 2 is generally to use more accurate sound source orientation methods for sound source orientation.

In certain optional implementation methods of some embodiments, the executing body may perform sound source orientation on the above conversation statement information to obtain first location information corresponding to the above conversation statement information by the following steps:

The first step is to separate the above conversation statement information to obtain separated conversation statement information. In practice, the executing body may use a wavelet separation algorithm to perform wavelet separation processing on the above conversation statement information to obtain separated conversation statement information. For example, the wavelet separation algorithm may be a Mallat algorithm.

The second step is to perform thresholding on the separated conversation statement information to obtain thresholded conversation statement information. In practice, the executing body may perform thresholding on the separated conversation statement information through a hard thresholding method to obtain the thresholded conversation statement information.

The third step is to reconstruct the thresholded conversation statement information to obtain reconstructed conversation statement information. In practice, the executing body may reconstruct the thresholded conversation sentence information through a method of wavelet inverse transform, to obtain reconstructed conversation sentence information.

The fourth step is, in response to determining that the reconstructed conversation statement information does not meet a preset single speech condition, to perform speech separation on the above conversation statement information to obtain speech separated conversation statement information. Wherein, the preset single speech condition may be that there is only one sound source corresponding to the conversation statement information. In practice, firstly, the executing body may use a MUSIC algorithm to determine the number of sound sources corresponding to the reconstructed conversation statement information, in order to determine whether the reconstructed conversation statement information meets the preset single speech condition. Then, in response to determining that the reconstructed conversation statement information does not meet the preset single speech condition, perform speech separation on the conversation statement information through a method of independent component analysis, to obtain speech separated conversation statement information.

The fifth step is to extract features from the above speech separated conversation statement information to obtain semantic features and timbre features corresponding to the above speech separated conversation statement information. In practice, firstly, the executing body may recognize the conversation statement information through speech recognition technology to obtain a speech text. Then, a BERT model may be used to extract semantic features from the obtained speech text and obtain extracted semantic features. Afterwards, the timbre features of the above conversation statement information may be extracted through a timbre feature extraction algorithm, to obtain extracted timbre features. For example, the timbre feature extraction algorithm may be a Mel frequency cepstral coefficient algorithm.

The sixth step is to recombine the above semantic features and the above timbre features to obtain recombined conversation statement information as conversation statement information. In practice, the executing body may recombine the above semantic features and the above timbre features through a conditional speech synthesis model to obtain recombined conversation statement information as conversation statement information.

The seventh step is to obtain multi-channel signal information corresponding to the above conversation statement information. Wherein, the above multi-channel signal information may characterize various audio signals corresponding to the above conversation statement information collected by multiple microphones. The above multiple microphones refer to the microphone arrays installed in the cabin of a vehicle. Here, there is no limitation on the number and location of the microphone arrays mentioned above. For example, the microphone arrays may be located on the ceiling inside the vehicle cabin.

The eighth step is to generate function information corresponding to the above multi-channel signal information based on the above multi-channel signal information. Wherein, the above function information may characterize a cross-correlation function. In practice, the above executing entity may generate function information corresponding to the above multi-channel signal information through a basic cross-correlation algorithm based on the multi-channel signal information.

The ninth step is to determine peak information corresponding to the above multi-channel signal information based on the above function information. Wherein, the above peak information may characterize various peak values corresponding to the above multi-channel signal information. In practice, the executing body may determine peak information corresponding to the above multi-channel signal information based on the above function information through a peak detection algorithm.

The tenth step is to determine delay information corresponding to the above multi-channel signal information based on the determined peak information. Wherein, the above delay information may characterize the delay matrix between the various channel signals in the above multi-channel signal information. In practice, the executing body may construct delay information corresponding to the above multi-channel signal information through a matrix construction algorithm.

The eleventh step is to determine direction angle information of the above conversation statement information based on the above delay information, collection device spacing information, and speed information. Wherein, the above device spacing information may characterize the distance between respective microphones. The above speed information may characterize the speed of sound. The above direction angle information may characterize the azimuth angle of the sound source relative to each microphone mentioned above. For example, the direction angle information may be the vertical direction of each microphone. In practice, the executing body may determine the direction angle information of the above conversation statement information based on the above delay information, collection device spacing information, and speed information through a sound source localization algorithm based on time delay estimation (TDE).

The twelfth step is to determine the location information corresponding to the above conversation statement information based on the above direction angle information. In practice, the above executing body may determine the location information corresponding to the above conversation statement information on the basis of the direction angle information, by algorithms based on time delay estimation and geometric positioning.

The above technical solution, as an inventive point of the embodiments of this disclosure, solves the technical problem 2: The factor that “results in low accuracy in sound source orientation performed directly according to the detected speech signal, leading to low accuracy in generating interference information and poor user experience” is often as follows: directly performing sound source orientation on the detected speech signal without considering preprocessing the detected speech signal. If the above factor is addressed, the accuracy of sound source orientation directly performed according to the detected speech signal may be improved, the accuracy of generating interference information may be enhanced, and the user experience may be improved. In order to achieve this effect, this disclosure first denoises the above conversation statement information to remove the noise within it, then performs sound source orientation based on the conversation statement information with less noise, thereby improving the accuracy of sound source orientation for conversation statement information.

Step 102: Based on the first location information and the conversation statement information, determining whether the conversation statement information meets preset privacy statement conditions.

In some embodiments, the executing body may determine whether the conversation statement information meets preset privacy statement conditions based on the first location information and the conversation statement information. Wherein, the preset privacy statement conditions may be: the above first location information belongs to the location information of the seats in the cabin of a vehicle, and the above conversation statement information is not a conversation between all personnel in the cabin of a vehicle.

In certain optional implementation methods of some embodiments, the executing body may determine, based on the above first location information and the above conversation statement information, whether the above conversation statement information meets preset privacy statement conditions, through the following steps:

The first step is to determine whether the above conversation statement information meets the preset interactive speech conditions based on the above first location information. Wherein, the above preset interactive speech conditions may be that: the location characterized by the above first location information is the current location information of the passenger seat in the cabin of a vehicle.

The second step is, in response to determining that the above conversation statement information meets the above preset interactive speech conditions, to determine whether the above conversation statement information meets the above preset privacy statement conditions.

In the process of adopting technical solutions to solve the above technical problem 1, the following technical problem 3 often accompanies it: judging whether it is a dialogue based solely on the conversation statement information, and judging whether it meets preset privacy statement conditions, result in low accuracy in judging whether the conversation statement information is a dialogue, leading to low accuracy in generating interference information, and poor user experience. The conventional solution to the above technical problem 3 is, in general, to repeatedly determine whether the conversation statement information is a dialogue.

In certain optional implementation methods of some embodiments, in response to determining that the above conversation statement information meets the above preset interactive speech conditions, the executing body may determine whether the above conversation statement information meets the above preset privacy statement conditions by the following steps:

The first step is to carry out the following steps in response to determining that the above first location information meets preset independent location conditions:

The first sub-step is to obtain historical conversation statement information. Wherein, the above historical conversation statement information may characterize the conversation statements within a preset time period before the above conversation statement information. Here, there is no specific time limit for the above preset time period. For example, the preset time period may be within the first 5 minutes. The above preset independent location conditions may be that the above first location information only includes one location.

The second sub-step is to determine similarity information between the above conversation statement information and historical conversation statement information. Wherein, the above similarity information may characterize the similarity between the semantics of the above conversation statement information and the semantics of the above historical conversation statement information. In practice, the executing body may use cosine similarity to determine the similarity between the above conversation statement information and historical conversation statement information.

The third sub-step is, in response to determining that the above similarity information is greater than preset similarity information, to determine that the above conversation statement information meets preset interactive speech conditions. Wherein, the above preset similarity information may characterize the set similarity. Here, there is no limitation on the specific numerical values of the above preset similarity information. For example, the similarity characterized by the preset similarity information may be 80%.

The fourth sub-step is to capture the image information inside the vehicle cabin as target image information. Wherein, the above target image information may characterize the captured image inside the vehicle cabin.

The fifth sub-step is, based on the above target image information, to determine the respective location information that meets preset manned conditions as respective target location information. Wherein, the target location information in the above respective target location information may characterize the seat that is not the above first location information but carries a user. The above preset manned conditions may be seat locations that are not characterized by the above first location information, and the characterized seat locations are occupied by users. In practice, the executing body may use an object detection algorithm to detect respective location information in the above image information that meets the above preset manned conditions. Here, there is no limitation on the specific type of the above object detection algorithm. For example, the object detection algorithm may be a YOLO algorithm.

The sixth sub-step is to determine whether the location information corresponding to the above historical conversation statement information meets preset full-load location conditions based on the above respective target location information. Wherein, the above preset full-load location conditions may be the location information corresponding to the above historical conversation statement information, not the seat location corresponding to the above conversation statement information, and include the above respective target location information.

The seventh sub-step is, in response to determining that the location information corresponding to the above historical conversation statement information does not meet the above preset full-load location conditions, to determine whether the above conversation statement information meets the above preset privacy statement conditions.

The second step is, in response to determining that the above first location information does not meet the above preset independent location conditions, to carry out the following steps:

The first sub-step is to obtain real-time video information from the above vehicle cabin. Wherein, the above real-time video information may characterize the video recorded in the vehicle cabin at the same time as the above conversation statement information. In practice, the executing body may obtain real-time video information corresponding to the above conversation statement information from a database that stores real-time video information.

The second sub-step is to detect the above real-time video information to obtain body language information corresponding to the above real-time video information. Wherein, the above body language information may characterize the body movements of the user in the vehicle cabin when making the voice of the above conversation statement information. For example, body language information may characterize a user turning her head towards other users or reaching out her hand. In practice, the executing body may detect the above real-time video information through a pose estimation algorithm, and obtain body language information corresponding to the above real-time video information. For example, the pose estimation algorithm may be a 2D pose estimation algorithm.

The third sub-step is to perform voiceprint recognition on the above conversation statement information to obtain voiceprint feature information corresponding to the above conversation statement information. Wherein, the above voiceprint feature information may characterize the voiceprint features of the above conversation statement information. In practice, the executing body may use a voiceprint feature extraction algorithm to perform voiceprint recognition on the above conversation statement information, to obtain voiceprint feature information corresponding to the above conversation statement information. For example, the voiceprint feature extraction algorithm may be a Mel frequency cepstral coefficient algorithm.

The fourth sub-step is to perform semantic detection on the above conversation statement information, to obtain semantic detection result information corresponding to the above conversation statement information. Wherein, the above semantic detection result information may characterize the semantics of the above conversation statement information. In practice, firstly, the executing body may perform semantic detection on the above conversation statement information through a semantic detection model, to obtain semantic detection result information corresponding to the above conversation statement information. For example, the semantic detection model may be a BERT model.

The fifth sub-step is to determine whether the above conversation statement information meets preset privacy statement conditions based on the above body language information, the above voiceprint feature information, and the above semantic detection result information. In practice, firstly, the executing body may fuse the above body language information, the above voiceprint feature information, and the above semantic detection result information through early fusion methods, to obtain fused body language information, voiceprint feature information and semantic detection result information as fusion feature information. Then, the obtained fusion feature information is input into a classifier to obtain dialogue detection result information corresponding to the above fusion feature information. Here, there is no limitation on the specific type of the above classifier. For example, the classifier may be a support vector machine (SVM). Wherein, the above dialogue detection result information may characterize whether the above conversation statement information is the detection result of the dialogue. Secondly, in response to determining that the dialogue detection result information characterizes the above conversation statement information as a dialogue, based on the above real-time video information, the respective location information corresponding to the above conversation statement information is determined as respective conversation location information. Lastly, in response to determining that the above respective conversation location information does not meet the location conditions for all-staff conversations, it is determined whether the above conversation statement information meets preset privacy statement conditions. Wherein, the above location conditions for all-staff conversations may be that the respective conversation location information is the vehicle cabin carrying inside it all the locations for users.

The above technical solution, as an inventive point of the embodiments of this disclosure, solves technical problem 3: The factor that “results in low accuracy in determining whether the conversation statement information is a dialogue, leading to low accuracy in generating interference information and poor user experience” is often as follows: judging whether it is a dialogue based solely on the conversation statement information, and judging whether it meets preset privacy statement conditions. If the above factor is addressed, it may improve the accuracy of determining whether the conversation statement information is a dialogue, enhance the accuracy of generating interference information, and improve the user experience. In order to achieve this effect, this disclosure uses the acquired real-time video information to obtain the body movements, voiceprint features, and semantic features corresponding to the above conversation statement information to jointly determine whether the above conversation statement information is a dialogue. It comprehensively improves the accuracy of judgment, thereby enhancing the accuracy of determining whether the conversation statement information is a dialogue, improving the accuracy of generating interference information, and ultimately improving the user experience.

Step 103: In response to determining that the conversation statement information meets the preset privacy statement conditions, generating the target interference information corresponding to the second location information in the cabin, to process the conversation statement information.

In some embodiments, the executing body may, in response to determining that the above conversation statement information meets the above preset privacy statement conditions, generating the target interference information corresponding to the second location information in the cabin, to process the above conversation statement information. Wherein, the above target interference information may characterize the interference signal to the above second location information. The above second location information may characterize the respective seats that need to mask the above conversation statement information. For example, the second location information may characterize: “the leftmost seat in the back row, the leftmost seat in the front row, and the middle seat in the back row”.

In certain optional implementation methods of some embodiments, the executing body may generate the target interference information corresponding to the second location information in the cabin through the following steps:

Step 1: In response to determining a preset generation method as the first generation method, resample the speech acquisition signal of the above conversation statement information to obtain the target interference information corresponding to the second location information in the cabin. Wherein, the above preset generation method may characterize the method used to generate target interference information. The above first generation method may characterize the use of resampling to generate target interference information.

In certain optional implementation methods of some embodiments, the executing body may resample the speech acquisition signal of the above conversation sentence information through the following steps to obtain the target interference information corresponding to the second location information in the cabin in order to process the above conversation sentence information:

The first step is to segment the above speech acquisition signal according to preset number of time periods, to obtain respective speech signal time period information. Wherein, the above preset number of time periods may characterize the number of divisions for the speech acquisition signal. The speech signal time period information in the above respective speech signal time period information may characterize the signals divided from the above speech acquisition signal. Here, there is no limitation to the specific number of the above preset time periods, which may be adjusted according to demand. In practice, the executing body may segment the above speech acquisition signal based on the above preset number of time periods, to obtain respective speech signal time period information.

The second step is to perform reverse sampling on the above respective speech signal time period information, in order to scramble the speech acquisition signal of the above conversation statement information to obtain the target interference information corresponding to the second location information in the cabin.

Step 2: In response to determining a preset generation method as the second generation method, perform sound quality equalization processing on the above conversation statement information, to obtain the conversation statement information after sound quality equalization processing as the target interference information corresponding to the second location information in the cabin. Wherein, the above second generation method may characterize the use of sound quality equalization processing to generate target interference information.

In certain optional implementation methods of some embodiments, the executing body may perform sound quality equalization processing on the above conversation statement information through the following steps, to obtain the conversation statement information after sound quality equalization processing as the target interference information corresponding to the second location information in the cabin, in order to process the above conversation statement information:

The first step is to determine the filtering parameter information corresponding to the above conversation statement information based on preset target timbre information and preset frequency range information. The above preset target timbre information may characterize the set timbre corresponding to the above conversation statement information. The above preset frequency range information may characterize the set frequency corresponding to the above conversation statement information. The above filtering parameter information may characterize the filtering parameters corresponding to the above conversation statement information. Here, there are no specific limitations on the above preset target timbre information and the above preset frequency range information, and they may be adjusted according to needs. In practice, the executing body may determine the filtering parameter information corresponding to the above conversation statement information based on the preset target timbre information and preset frequency range information through parameter setting methods based on spectrum analysis or based on adaptive algorithms.

The second step is, based on the above filtering parameter information, to perform sound quality equalization processing on the above conversation statement information, and obtain the conversation statement information after sound quality equalization processing as the target interference information corresponding to the second location information in the cabin. In practice, the executing body may perform sound quality equalization processing on the above conversation statement information based on the filtering parameter information, to obtain the conversation statement information after sound quality equalization processing as the target interference information corresponding to the second location information in the cabin.

Step 3: In response to determining a preset generation method as the third generation method, based on the above conversation statement information, modify the preset noise information to obtain updated preset noise information as the target interference information corresponding to the second location information in the cabin. Wherein, the above third generation method may characterize the generation of target interference information based on preset noise information. The above preset noise information may characterize natural white noise. For example, the preset noise information may be the sound of water flow, insect stridulating, or bird chirping.

In certain optional implementation methods of some embodiments, the executing body may modify the preset noise information based on the above conversation statement information through the following steps, and obtain updated preset noise information as the target interference information corresponding to the second location information in the cabin, in order to process the conversation statement information:

The first step is to determine the signal-to-noise ratio information based on the speech acquisition signal information of the above conversation statement information and the above preset noise information. The above signal-to-noise ratio information may characterize the signal-to-noise ratio between the speech acquisition signal information of the above conversation statement information and the above preset noise information. In practice, firstly, the executing body may determine the power of the above speech acquisition signal information and the power of the above preset noise information through an algorithm for finding the sum of squares. Then, the ratio between the power of the above conversation statement information and the power of the above preset noise information may be determined as the signal-to-noise ratio information.

The second step is to adjust the amplitude information of the power spectrum function of the above preset noise information based on the above signal-to-noise ratio information, in order to modify the above preset noise information and obtain updated preset noise information. Wherein, the above amplitude information of the power spectrum function may characterize the amplitude of the power spectrum of the above preset noise. In practice, the executing body may adjust the amplitude of the power spectrum function of the above preset noise information based on the above signal-to-noise ratio information according to the power amplifier technology, in order to obtain updated preset noise information. For example, when the signal-to-noise ratio information is greater than (first threshold+second threshold), amplify the amplitude of the power spectrum function of the above preset noise information; When the signal-to-noise ratio information is less than (first threshold-second threshold), suppress the amplitude of the power spectrum function of the above preset noise information; Maintain the signal-to-noise ratio information determined based on the updated preset noise information at a level of (first threshold±second threshold) to order to ensure masking effect while improving auditory comfort for individuals sitting in the masked seat location at the same time. Here, there is no limitation on the specific values of the above first threshold and the above second threshold. For example, the first threshold may be set to 1.0, and the second threshold may be set to 20%.

The third step is to determine the updated preset noise information as the target interference information corresponding to the second location information in the cabin.

Optionally, the executing body may also send the above target interference information to at least one speaker corresponding to the above second location information, so that at least one speaker corresponding to the above second location information may play the target interference information. It should be noted that each seat in the cabin is equipped with at least one speaker.

The above embodiments of this disclosure have the following beneficial effects: through the sound processing method applied in the cabin of a vehicle by some embodiments of this disclosure, the effect of conversation in the cabin is enhanced and the user experience in the cabin is improved. To be specific, the reason for the rather bad effect of conversation in the cabin and the poor user experience in the cabin is that: using physical isolation methods for sound insulation in the cabin requires a large amount of sound insulation materials, which seriously damages the optimization design of the cabin space and affects the conversation effect in the cabin when no sound insulation is required, thus resulting in a poor user experience in the cabin. On this basis, the sound processing method applied in a vehicle cabin by some embodiments of this disclosure comprises, firstly, based on the detected conversation statement information in a vehicle cabin, determining the first location information corresponding to the above conversation statement information. From this, the location where the sound is emitted may be determined. Then, based on the above first location information and the above conversation statement information, determining whether the above conversation statement information meets preset privacy statement conditions. From this, it may be determined whether the content of the conversation is private and whether it needs to be treated as private. Lastly, in response to determining that the above conversation statement information meets the above preset privacy statement conditions, generating the target interference information corresponding to the second location information in the cabin, to process the above conversation statement information. Therefore, when the conversation content is private, interference information may be generated to effect sound masking. It is also because the sound is not isolated by physical isolation methods, but is masked by generating interfering sounds, deterioration of the spatial structure design of the cabin is avoided, and impact on the conversation effect in the cabin when no sound insulation is required is also reduced, thereby improving the user experience. As a result, the conversation effect in the cabin may be enhanced and the user experience in the cabin improved.

Further referring to FIG. 2, as an implementation of the method shown in the above figures, this disclosure provides some embodiments of a sound processing device applied in the cabin of a vehicle, which correspond to the method embodiments shown in FIG. 1. The device may be specifically applied to various electronic apparatus.

As shown in FIG. 2, the sound processing device 200 applied in the cabin of a vehicle, of some embodiments, includes: a first determination unit 201, a second determination unit 202, and a generation unit 203. Wherein, the first determination unit is configured to determine, based on the detected conversation statement information in the cabin of a vehicle, first location information corresponding to the above conversation statement information; the second determination unit is configured to determine, based on the above first location information and the above conversation statement information, whether the above conversation statement information meets preset privacy statement conditions; the generation unit is configured to generate, in response to determining that the above conversation statement information meets the above preset privacy statement conditions, the target interference information corresponding to the second location information in the cabin, to process the above conversation statement information.

It may be understood that the various units comprised in the sound processing device 200 applied in the cabin of a vehicle correspond to the steps in the method illustrated in FIG. 1. Therefore, the operations, features, and beneficial effects described above for the method also apply to the device 200 and the units comprised therein, and will not be repeated here.

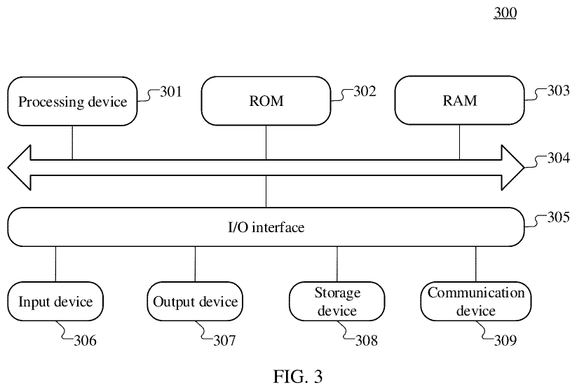

Referring to FIG. 3 below, a schematic diagram of the structure of the electronic apparatus (such as computing apparatus) 300 suitable for effecting some embodiments of this disclosure is shown. The electronic apparatus shown in FIG. 3 is only an example and should not impose any limitations on the functionality and scope of use of the embodiments of this disclosure.

As shown in FIG. 3, the electronic apparatus 300 may comprise a processing device (such as a central processing unit, graphics processor, etc.) 301, which may perform various appropriate actions and processes based on programs stored in a read-only memory (ROM) 302 or programs loaded from a storage device 308 into a random access memory (RAM) 303. In the RAM 303, various programs and data required for the operation of the electronic apparatus 300 are also stored. The processing device 301, ROM 302, and RAM 303 are connected to each other through a bus 304. An input/output (I/O) interface 305 is also connected to the bus 304.

Typically, the following devices may be connected to the I/O interface 305: input device 306 such as touch screen, touchpad, keyboard, mouse, camera, microphone, accelerometer, gyroscope, etc.; output device 307 such as liquid crystal display (LCDs), speaker, vibrator, etc.; storage device 308 such as magnetic tape, hard drive, etc.; and a communication device 309. The communication device 309 allows the electronic apparatus 300 to communicate wirelessly or wired with other devices to exchange data. Although FIG. 3 shows an electronic apparatus 300 with various devices, it should be understood that there is no requirement for effecting or having all of the shown devices. It may effect or have more or fewer devices as an alternative. Each box shown in FIG. 3 may represent one device or multiple devices as needed.

Specifically, according to some embodiments of this disclosure, the process described above with reference to the flowchart may be implemented as a computer software program. For example, some embodiments of this disclosure include a computer program product comprising a computer program carried on a computer-readable medium, the computer program comprising program code for executing the method shown in the flowchart. In such embodiments, the computer program may be downloaded and installed from the network through communication device 309, or installed from storage device 308, or installed from ROM 302. When the computer program is executed by processing device 301, the above functions defined in some embodiments of this disclosure are executed.

It should be noted that the computer-readable medium described in some embodiments of this disclosure may be a computer-readable signal medium or a computer-readable storage medium, or any combination of the above two. Computer readable storage media may be, but are not limited to, for example, systems, devices, or components of electricity, magnetism, light, electromagnetism, infrared, or semiconductors, or any combination thereof. More specific examples of computer-readable storage media may include, but are not limited to, electrical connections with one or more wires, portable computer disks, hard drives, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof. In some embodiments of this disclosure, a computer-readable storage medium may be any tangible medium containing or storing a program that may be used by or in combination with an instruction execution system, device or component. In some embodiments of this disclosure, the computer-readable signal medium may include data signals propagated in the baseband or as part of a carrier wave, carrying computer-readable program code. This type of propagated data signals may take various forms, including but not limited to electromagnetic signals, optical signals, or any suitable combination thereof. The computer readable signal medium may also be any computer-readable medium other than the computer-readable storage medium. The computer readable signal medium may send, propagate, or transmit programs for use by or in combination with instruction execution systems, devices, or components. The program code contained on a computer-readable medium may be transmitted using any suitable medium, including but not limited to: wires, optical cables, RF (radio frequency), etc., or any suitable combination of the above.

In some implementations, clients and servers may communicate using any currently known or future developed network protocol such as HTTP (HyperText Transfer Protocol), and may be interconnected with any form or medium of digital data communication (e.g. communication network). Examples of communication networks include local area networks (“LANs”), wide area networks (“WANs”), internet (for example, the Internet), and end-to-end networks (for example, ad hoc end-to-end networks), as well as any currently known or future developed networks.

The above computer-readable medium may be comprised in the electronic apparatus mentioned above; It may also exist independently without being assembled into the electronic apparatus. The above computer-readable medium carries one or more programs which, when executed by the electronic apparatus, cause the electronic apparatus to: based on the detected conversation statement information in the cabin of a vehicle, determine first location information corresponding to the above conversation statement information; based on the above first location information and the above conversation statement information, determine whether the above conversation statement information meets preset privacy statement conditions; in response to determining that the above conversation statement information meets the above preset privacy statement conditions, generate the target interference information corresponding to the second location information in the cabin, to process the above conversation statement information.

Computer program code for performing the operations of some embodiments of this disclosure may be written in one or more programming languages or combinations thereof, including object-oriented programming languages such as Java, Smalltalk, C++, as well as conventional procedural programming languages such as “C” language or similar programming languages. Program code may be executed entirely on the user's computer, partially on the user's computer, as a standalone software package, partially on the user's computer partially on a remote computer, or entirely on a remote computer or server. In cases involving a remote computer, the remote computer may be connected to the user's computer through any type of network, including a local area network (LAN) or a wide area network (WAN), or may be connected to an external computer (such as using an Internet service provider to connect via the Internet).

The flowcharts and block diagrams in the attached figures illustrate the architecture, functions, and operations that may possibly be implemented by the system, method, and computer program product according to various embodiments of this disclosure. In this regard, each box in a flowchart or block diagram may represent a module, program segment, or part of code, the module, program segment, or part of code containing one or more executable instructions for implementing specified logical functions. It should also be noted that in some alternative implementations, the functions marked in the boxes may also occur in a different order than those marked in the figures. For example, two consecutive boxes may actually be executed in parallel, and sometimes they may also be executed in reverse order, depending on the functions involved. It should also be noted that each box in the block diagram and/or flowchart, as well as combinations of boxes in the block diagram and/or flowchart, may be implemented using dedicated hardware based systems that perform specified functions or operations, or may be implemented using a combination of dedicated hardware and computer instructions.

The units described in some embodiments of this disclosure may be implemented through software or hardware. The described units may also be set in the processor, for example, it may be described as: a processor comprising a first determination unit, a second determination unit, and a generation unit. Wherein, the names of these units in some cases do not constitute limitations on the units per se. For example, the first determination unit may also be described as “a unit that determines, based on the detected conversation statement information in the cabin of a vehicle, the first location information corresponding to the above conversation statement information”.

The functions described above may be at least partially executed by one or more hardware logic components. For example, not restrictively, exemplary types of hardware logic components may be used, including: Field Programmable Gate Arrays (FPGAs), Application Specific Integrated Circuits (ASICs), Application Specific Standard Products (ASSPs), System on Chip (SOC), Complex Programmable Logic Devices (CPLDs), and so on.

The above description is merely some preferred embodiments of this disclosure and illustrations of the applied technical principles. Those skilled in the art should understand that the scope of the disclosure involved in the embodiments of this disclosure is not limited to the technical solutions formed by the specific combination of the above technical features, but should cover at the same time, without departing from the above inventive concept, other technical solutions formed by any combination of the above technical features or their equivalent features, for example, a technical solution formed by replacing the above features with the technical features of similar functions disclosed (but not limited to) in the embodiments of this disclosure.

1. A sound processing method applied in a cabin of a vehicle, comprising:
based on detected conversation statement information in the cabin of the vehicle, determining first location information corresponding to the conversation statement information;
based on the first location information and the conversation statement information, determining whether the conversation statement information meets preset privacy statement conditions;
in response to determining that the conversation statement information meets the preset privacy statement conditions, generating target interference information corresponding to second location information in the cabin, to process the conversation statement information.

2. The method of claim 1, wherein, the based on detected conversation statement information in the cabin of the vehicle, determining the first location information corresponding to the conversation statement information, includes:
performing sound source orientation on the conversation statement information, to obtain location information corresponding to the conversation statement information as the first location information.

3. The method of claim 1, wherein, the based on the first location information and the conversation statement information, determining whether the conversation statement information meets preset privacy statement conditions, includes:
determine whether the conversation statement information meets the preset interactive speech conditions based on the first location information; in response to determining that the conversation statement information meets the preset interactive speech conditions, determining whether the conversation statement information meets the preset privacy statement conditions.

4. The method of claim 1, wherein, the generating the target interference information corresponding to the second location information in the cabin includes:
in response to determining a preset generation method as a first generation method, resampling a speech acquisition signal of the conversation statement information, to obtain the target interference information corresponding to the second location information in the cabin;
in response to determining a preset generation method as a second generation method, performing sound quality equalization processing on the conversation statement information, to obtain the conversation statement information after sound quality equalization processing as the target interference information corresponding to the second location information in the cabin;
in response to determining a preset generation method as a third generation method, based on the conversation statement information, modifying preset noise information to obtain updated preset noise information as the target interference information corresponding to the second location information in the cabin.

5. The method of claim 4, wherein, the resampling the speech acquisition signal of the conversation statement information, to obtain the target interference information corresponding to the second location information in the cabin, includes:
segmenting the speech acquisition signal according to preset number of time periods, to obtain respective speech signal time period information;
performing reverse sampling on the respective speech signal time period information, in order to scramble the speech acquisition signal of the conversation statement information, to obtain the target interference information corresponding to the second location information in the cabin.

6. The method of claim 4, wherein, the performing sound quality equalization processing on the conversation statement information, to obtain the conversation statement information after sound quality equalization processing as the target interference information corresponding to the second location information in the cabin, includes:
determining filtering parameter information corresponding to the conversation statement information, based on preset target timbre information and preset frequency range information;
performing sound quality equalization processing on the conversation statement information based on the filtering parameter information, to obtain the conversation statement information after sound quality equalization processing as the target interference information corresponding to the second location information in the cabin.

7. The method of claim 4, wherein, the based on the conversation statement information, modifying the preset noise information to obtain updated preset noise information as the target interference information corresponding to the second location information in the cabin, includes:
determining signal-to-noise ratio information based on the speech acquisition signal information of the conversation statement information and the preset noise information;
adjusting amplitude information of power spectrum function of the preset noise information based on the signal-to-noise ratio information, in order to modify the preset noise information and obtain updated preset noise information;
determining the updated preset noise information as the target interference information corresponding to the second location information in the cabin.

8. A sound processing device applied in a cabin of a vehicle, comprising:
a first determination unit, which is configured to determine, based on detected conversation statement information in the cabin of the vehicle, first location information corresponding to the conversation statement information;
a second determination unit, which is configured to determine, based on the first location information and the conversation statement information, whether the conversation statement information meets preset privacy statement conditions;
a generation unit, which is configured to generate, in response to determining that the conversation statement information meets the preset privacy statement conditions, target interference information corresponding to second location information in the cabin, to process the conversation statement information.

9. An electronic apparatus, comprising:
one or more processors;
a storage device, on which one or more programs are stored;
the one or more programs, when executed by the one or more processors, enable the one or more processors to implement the method described in claim 1.

10. A computer-readable medium, with a computer program stored thereon, wherein the computer program, when executed by a processor, implements the method described in claim 1.
